(19) United States
(12) Patent Application Publication
(10) Pub. No.: US 2014/0304616 A1
(43) Pub. Date: Oct. 9, 2014

(54) MOBILE TERMINAL AND METHOD FOR PROCESSING NOTIFICATION INFORMATION

(71) Applicant: Pantech Co., Ltd., Seoul (KR)

(72) Inventors: Jin Ho PARK, Seoul (KR); Sang Heon KWAK, Seoul (KR); Kyung Ku CHO, Seoul (KR)

(73) Assignee: Pantech Co., Ltd., Seoul (KR)

(21) Appl. No.: 14/245,508

(22) Filed: Apr. 4, 2014

(30) Foreign Application Priority Data
Apr. 4, 2013 (KR) 10-2013-0036808

(51) Int. Cl. H04L 12/58; G06F 3/0485

(52) U.S. Cl. CPC H04L 51/24; G06F 3/0485
USPC 715/752; 715/764; 715/784

(57) ABSTRACT

Provided is a terminal and method for processing received notification information. A mobile terminal to process notification information includes a receiver to receive first notification data associated with a first application installed in a mobile terminal, a processor to extract identification information for identifying a target of the first notification data, and to generate a first notification list item by grouping the first notification data with second notification data based on the identification information, and a display screen to display notification list items including the first notification list item on a notification panel.

### CROSS-REFERENCE TO RELATED APPLICATION

This application claims priority from and the benefit under 35 U.S.C. §119(a) of Korean Patent Application No. 10-2013-0036808, filed on Apr. 4, 2013, which is hereby incorporated by reference for all purposes as if fully set forth herein.

### BACKGROUND

1. Field

The present disclosure relates to a terminal and method for processing received notification information.

2. Discussion of the Background

With the development in technology of mobile terminals, types of programs and the number of programs executable in mobile terminals have been increased. In association with programs installed in mobile terminals, program related information is processed by a notification service and displayed on a screen. If a plurality of notification events occurs, each of the plurality of notification events may be sequentially stacked in a corresponding order and then be displayed on a screen.

For example, a received notification event may be displayed on an annunciator of a terminal. When a program that is a target of a notification event is provided in a messenger type, for example, KakaoTalk and Line, only the most recently received notification event is displayed on the annunciator. Accordingly, a corresponding program needs to be executed in order to verify a previously received notification event.

Also, when a program is provided in a different type, for example, a mobile game, a plurality of notification events may be displayed on the annunciator with respect to a single program and thus, the screen may be filled with unnecessary notification information.

### SUMMARY

Exemplary embodiments of the present invention provide a terminal and method for processing notification information.

Additional features of the invention will be set forth in the description which follows, and in part will be apparent from the description, or may be learned by practice of the invention.

Exemplary embodiments of the present invention provide a method that uses a processor to process notification information, the method including: receiving first notification data associated with a first application installed in a mobile terminal; extracting identification information for identifying a target of the first notification data; generating a first notification list item by grouping the first notification data with second notification data based on the identification information; and displaying notification list items including the first notification list item on a notification panel.

Exemplary embodiments of the present invention provide a mobile terminal to process notification information, including: a receiver to receive first notification data associated with a first application installed in a mobile terminal; a processor to extract identification information for identifying a target of the first notification data, and to generate a first notification list item by grouping the first notification data with second notification data based on the identification information; and a display screen to display notification list items including the first notification list item on a notification panel.

Exemplary embodiments of the present invention provide a method that uses a processor to process notification information, the method including: receiving first notification data associated with an application installed in a mobile terminal; extracting identification information for identifying a target of the first notification data; determining if the application is of a first type or of a second type, based on the extracted identification information; generating a first notification list item by grouping the first notification data with second notification data based on the identification information and the determined type of the application; and displaying notification list items including the first notification list item on a notification panel.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A, FIG. 1B, and FIG. 1C illustrate interfaces to process notification information according to an exemplary embodiment of the present invention.

FIG. 2 illustrates a mobile terminal to provide a notification processing interface according to an exemplary embodiment of the present invention.

FIG. 3 illustrates an interface of processing and displaying a notification list according to an exemplary embodiment of the present invention.

FIG. 4 illustrates a configuration of a notification data input to a mobile terminal according to an exemplary embodiment of the present invention.

FIG. 5 illustrates a mobile terminal to provide a notification processing interface according to another exemplary embodiment of the present invention.

FIG. 6 illustrates an interface of displaying a process of verifying a previous notification item and/or list using a mobile terminal according to an exemplary embodiment of the present invention.

FIG. 7 illustrates a method for processing notification information according to an exemplary embodiment of the present invention.

FIG. 8 illustrates a method for processing notification information according to an exemplary embodiment of the present invention.

FIG. 9 illustrates a method for processing notification information according to still another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element is referred to as being “connected to” another element, it can be directly connected to the other element, or intervening elements may be present.

Hereinafter, exemplary embodiments of the present invention will be described with reference to the accompanying drawings.

In general, a mobile device may include a hardware layer, a platform to process a signal input from the hardware layer and to transfer the processed input signal, and an application program layer operated based on the platform and including various types of application programs.

A platform may be classified into Android™ platform, Windows® mobile platform, Apple® operating system (iOS®) platform, and the like, based on an operating system (OS) of a mobile device. Each platform may have a different structure, but may have an identical or similar basic functionality.

The Android™ platform serves to manage various types of hardware components, and may include a Linux kernel layer to transfer a request of an application program to a hardware component, and to transfer a response of the hardware component to the application program, a library layer including, e.g., C or C++ based libraries, to connect hardware and a framework layer, and the framework layer to manage various types of application programs.

In the Windows® mobile platform, a windows core layer corresponds to the Linux kernel layer. The Windows® mobile platform may include an interface layer to connect the windows core layer and an application program layer, and to support various types of languages and functions.

In the iOS® platform, a core OS layer corresponds to the Linux kernel layer. A core service layer may be similar to the library layer and the framework layer. The iOS® platform may include a media layer to provide a multimedia function and a cocoa touch layer to serve as a layer for various types of applications.

Herein, each layer may also be referred to as a block, and the framework layer and a similar layer corresponding thereto may be defined as a software block. The following exemplary embodiments may be configured on a variety of platforms of a mobile device, but are not limited to the aforementioned platform types.

A “program” may be software for providing a predetermined service or function in the mobile terminal. The program may include an application or a widget, and may include a service object or an application in an Always On Top (AOT) form. In the Android™ OS, the program may include an application (or App.), and may also include a service object.

In the following description, notification information may include information associated with a program and/or information associated with a system or associated with a function of a mobile terminal.

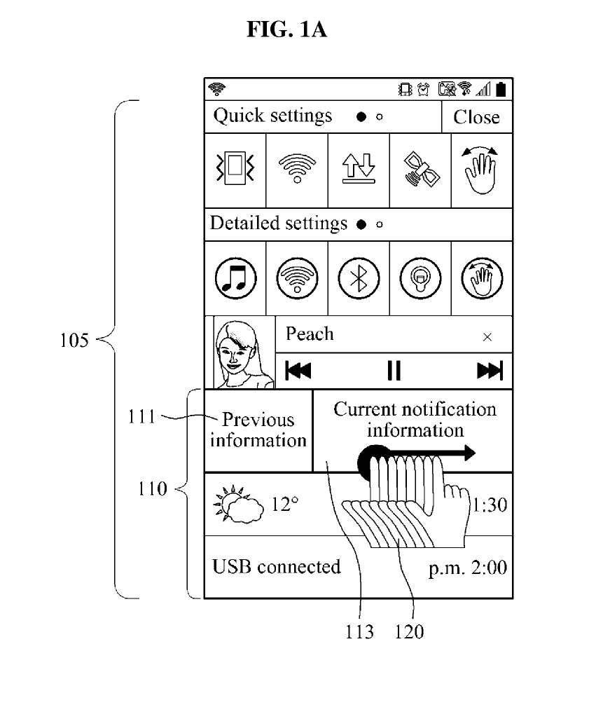

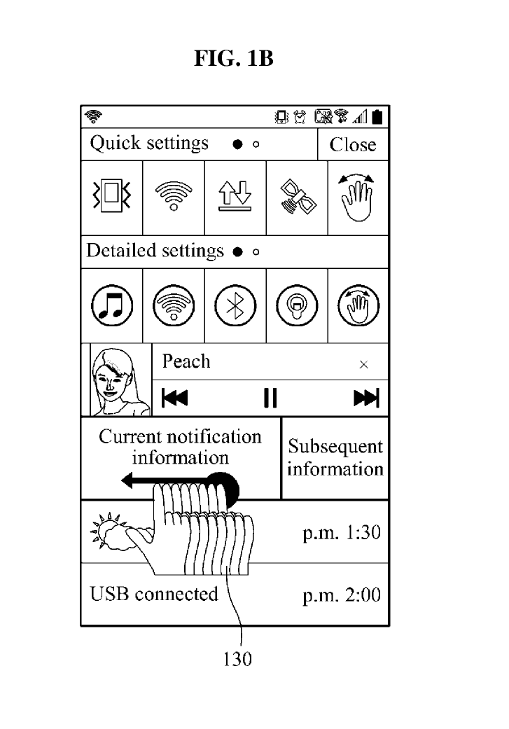

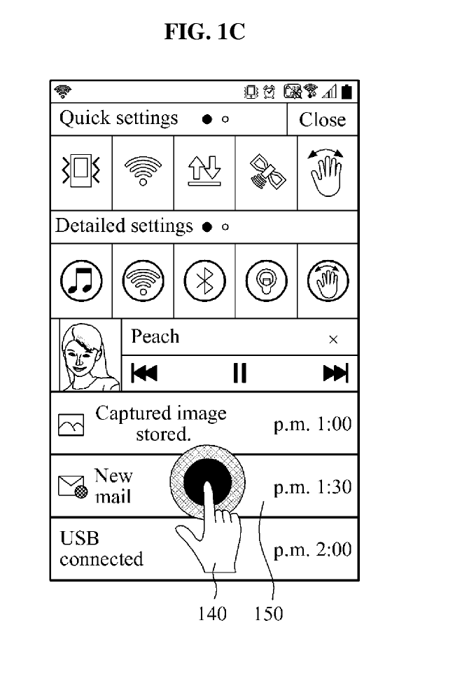

FIG. 1A, FIG. 1B, and FIG. 1C illustrate interfaces to process notification information according to an exemplary embodiment of the present invention.

Referring to FIG. 1A, notification lists 110 may be displayed on an annunciator 105 of a terminal. The annunciator 105 indicates or provides a notification window for displaying information about a variety of settings, such as communication, a program, and a brightness of the terminal, for example. The annunciator 105 may be provided in various user interface types, including a bar type. The notification lists 110 may include notification information to indicate new information associated with a program. Here, the program may be a widget as well. The notification information may also include information associated with a system and a function of the mobile terminal.

For example, a notification panel, e.g., a designated area in the annunciator 105, may be assigned to the annunciator 105. The notification lists 110 may be displayed at a position of the assigned notification panel. According to a notification information processing method, when a user inputs a predetermined gesture 120 on the notification panel on which a notification list 113 is displayed, notification information 111, e.g., previously stored or created notification list, in association with the predetermined notification information 113, e.g., the selected current notification list 113, may be displayed on the notification panel. Here, the predetermined gesture 120 input by the user may be defined in various forms, such as a flicking operation in a predetermined direction (e.g., from the left to the right), a short touch, a long touch, multiple touches, a multitouch, and a flicking operation in a predetermined direction after vertically extending a predetermined notification list, for example, after a pinch-to-zoom operation. Meanwhile, the gesture 120 may include a variety of non-touch inputs, such as a motion recognition and a voice recognition, in addition to the aforementioned touch inputs. The predetermined gesture 120 may be defined in a form having a specific direction. In an example, if the user of the mobile terminal inputs the gesture 120 without retrieving the detailed information of the current notification information, the mobile terminal may delete the current notification information 113 from the notification list and display the previous information 111 in the notification list. Since the user may retrieve detailed information of the current notification information by executing the associated application or program, such a scheme may provide the user with a convenient user interface to delete confirmed notification information without individually retrieving the detailed information thereof.

For example, in addition to the latest notification information, previous notification information may be displayed on the annunciator 105 in response to an input of the gesture 120 having a specific direction. A mapping relationship between the direction of the gesture 120 and notification information to be displayed maybe variously modified or set based on settings of the terminal or manual settings of the user.

Referring to FIG. 1B, in response to an input of a predetermined gesture 130, information subsequently stored or created in association with a predetermined notification list may be displayed on a notification panel. Here, the predetermined gesture 130 input by the user may be defined in various forms, such as a flicking operation in a predetermined direction (e.g., from the right to the left), a short touch, a long touch, multiple touches, a multitouch, and a flicking operation in a predetermined direction after vertically extending a predetermined notification list, for example, after a pinch-to-zoom operation. The gesture 130 may include a variety of non-touch inputs, such as a motion recognition and a voice recognition, in addition to the aforementioned touch inputs. The predetermined gesture 130 may also be defined in a form having a specific direction. Further, the gesture 120 and the gesture 130 may be the same type of input but have different directions.

In response to the gesture 130 input in a state in which the previously stored notification information 111 is displayed on the notification panel as illustrated in FIG. 1A, notification information 113 stored after the storage of the notification information 111 may be displayed on the notification panel. In a case in which the gestures 120 and 130 have associated directions, the directions of the gestures 120 and 130 may be opposite to each other. For example, the gesture 120 may be set as a flicking operation in a direction from the left to the right as illustrated in FIG. 1A to display previously stored or created information, the gesture 130 may be set as a flicking operation from the right to the left as illustrated in FIG. 1B to display subsequently stored or created information.

A notification list may include notification information associated with a program. Notification list data may be stored in a storage space as a file that includes not only the most recently received information but also the previously received or created information. For example, the storage space may include a cache, a memory, and a database. The notification information may be continuously accumulated or stacked in notification list data and thereby be stored based on a set criterion, such as, a counted number and a period. In response to a predetermined gesture input on a notification panel, notification list data about a corresponding notification list may be retrieved from the storage space. In response to an input of a gesture, the notification information may be displayed on the notification panel based on a storage order of the notification information included in the corresponding notification list data.

Referring to FIG. 1C, in response to a predetermined gesture 140 input on a predetermined notification list 150, the predetermined notification list 150 may be deleted from the annunciator 105. A gesture to delete at least one piece of notification information from the notification list 150 or a gesture to delete a notification list, e.g., the notification list 150, may be referred to as a notification deletion input. Here, the predetermined gesture 140 input by the user may be defined in various forms, such as a short touch, a long touch, multiple touches, a multitouch, and a flicking operation in a predetermined direction (e.g., a direction from the right to the left or a direction from the left to the right). The gesture 140 may also include a variety of non-touch points, such as a motion recognition and a voice recognition, in addition to the aforementioned touch inputs.

By enabling the user to read previous notification information using horizontal flicking, a further intuitive interface may be provided and an alternative for an existing interface processing scheme may be provided. Interface examples and user input schemes, for example, a touch input scheme, such as horizontal flicking and a long press, are only examples and thus, a variety of user interfaces that enable the user to read previous or subsequent notification information may be provided regardless of which interface and user input scheme are used. If a linked portion retrieval input is received on the notification list 150, the mobile terminal may execute an email application to display the received new email or a list of emails including the new email of which information is displayed in the notification list 150.

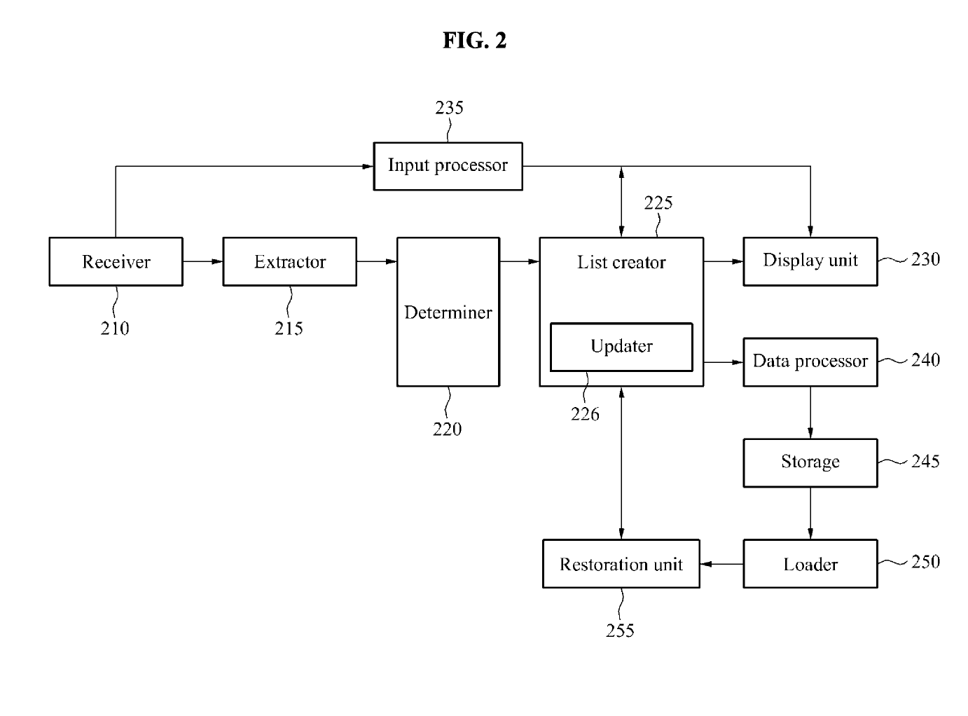

FIG. 2 illustrates a mobile terminal to provide a notification processing interface according to an exemplary embodiment of the present invention.

Referring to FIG. 2, the mobile terminal may include a receiver 210, an extractor 215, a determiner 220, a list creator 225, a display unit 230, an input processor 235, a data processor 240, a storage 245, a loader 250, and a restoration unit 255. Each of the constituent elements of FIG. 2 may be physically classified or separate and at least two thereof may be configured in a single hardware component, but may be logically and functionally separate.

The receiver 210 may receive notification data about a program. For example, the receiver 210 may receive program related information from a web server. Program related information may include various types of information such as a message, update information, request a friend, and new feed information, for example.

Program related information may be input as notification data for providing information associated with a program to a terminal.

The extractor 215 may extract, from the notification data, identification information for identifying a target of a notification and content including a description of the notification. Here, the identification information may include at least one of an identifier for identifying a program, a title, and an attribute. The title may include at least one of a name of the program and an identification of a sender sending a message using the program.

For example, the identifier of the program may be an identification (ID) indicating the program. Meanings of the identifier, the title, and the content may differ based on a type of the program.

The type of the program may be generally classified into a messenger type and a non-messenger type.

If the program is the messenger type program, the identifier may match a name of the program, the title may include an identification of a sender sending a message using the program, and the content may include a detailed description of the message. For example, if the program is a messenger type program, an ID of the program stored in the terminal is identical to an identifier included in notification data and a matching name of the program may be retrieved from the identifier of notification data.

If the program is not provided in the messenger type, the title may include a name of the program and the content may include a detailed description of a notification. For example, when the program is provided in a mobile web game genre, the content may include information about a schedule that needs to be periodically performed on a game. If the program is not provided in the messenger type, an identifier indicating the same program may be frequently changed. Accordingly, the program may not be accurately identified using the identifier of the program alone. The same programs may be identified using the title. Also, the program may be identified using a combination of the identifier and the title.

Whether the program is provided in the messenger type may be determined based on the identifier of the notification data.

The determiner 220 may identify a program that is a target of the notification from among programs installed in the mobile terminal based on the identification information. For example, the determiner 220 may identify a program associated with notification data using the identifier and/or title extracted by the extractor 215.

For example, the determiner 220 may identify a program having the same identifier as the extracted identifier.

When a program having the same identifier as the extracted identifier is not identified, the determiner 220 may identify a program having the same title as the extracted title from among programs stored in the terminal.

As another example, even though a program having the same identifier as the extracted identifier is identified, the determiner 220 may identify a program having the same title as the extracted title from among programs having the same identifier.

The determiner 220 may determine whether the program is a messenger type program using an attribute of notification data and then identify the same program using the identifier or the title based on the determination result.

The list creator 225 may create a notification list based on various classification conditions/criteria according to settings of a user or a system.

For example, the list creator 225 may create at least one notification list by grouping contents of notification data based on identification information. The list creator 225 may create a notification list based on at least one of the identifier and the title.

For example, with respect to a program having the same identifier as the extracted identifier, the list creator 225 may create a notification list including contents based on the extracted title. The list creator 225 may create a separate notification list for each title using the same program. For example, if the program is provided in the messenger type, the list creator 225 may create a notification list for each message sender. For the same program, senders may be different. For different message senders in the same program, different notification lists may be created. Since a notification list is created for each sender, a user may verify a received message for each sender without executing a program.

As another example, with respect to a program having the same title as the extracted title, the list creator 225 may create a notification list including contents based on the extracted title. When the same program is identified using the title, the list creator 225 may create a notification list including contents using the same program. For example, if the program is provided in a game type, the list creator 225 may create a single notification list with respect to the same game program. Since a single notification list is created, relevant information may be briefly displayed for each program on the annunciator.

The list creator 225 may include an updater 226.

If a notification list having the same identification information as identification information of notification data is previously created, the updater 226 may update the previously created notification list to include contents extracted by the extractor 215.

For example, with respect to a program having the same identifier, if a single notification list was previously created based on the extracted title, the updater 226 may update the created notification list to include the extracted contents. More specifically, if a notification list was previously created with respect to the same sender of the same program, the updater 226 may add a new message to the created notification list. As another example, if a notification list was previously created with respect to the same game program, the updater 226 may add new game related contents to the created notification list.

The display unit 230 may display each notification list on a notification panel. Each notification list may be classified based on a classification criterion and thereby be displayed on the notification panel. For example, the classification criterion may include an identifier and/or title extracted by the extractor 215. As another example, the classification criterion may be variously set based on settings of a user or a system.

The notification list created for each program by the list creator 225 may be displayed by the display unit 230. Each of the notification lists created by the list creator 225 for the respective senders with respect to the same program, e.g., a program of the messenger type, may be displayed by the display unit 230.

The display unit 230 may display the classified notification list on the annunciator. Here, the notification panel may be assigned to a predetermined area of the annunciator.

The input processor 235 may recognize a user input. The user input may include a touch input and/or a non-touch input. For example, a motion recognition may be a scheme of recognizing a motion of a user horizontally moving a hand on a camera or an image sensor of a mobile terminal. The motion recognition may be a scheme of horizontally moving or shaking the mobile terminal.

For example, in response to a touch input on the notification panel, the input processor 235 may recognize a gesture event matching the touch input. The input processor 235 may recognize a drag, a flicking, and the like, based on a direction of the touch input. The input processor 235 may recognize a multi-touch input based on the number of multiple touches. The input processor 235 may apply, to the notification list, a process set with respect to the recognized gesture event. A processing process may be set for each gesture event. For example, a processing process of displaying previous notification information may be set with respect to a first flicking, e.g., a flicking in a direction from the left to the right, and a processing process of displaying subsequent notification information may be set with respect to a second flicking, e.g., a flicking in a direction from the right to the left. Also, a process of deleting a notification list corresponding to a touch input may be set with respect to a long pressed touch. A variety of processes may be set with respect to various gestures using a touch input. Referring to FIG. 1A, the previous information 111 and the current notification information 113 may be included in a notification list item associated with the same application or the same program and grouped into the notification list item to avoid display of multiple notification list items associated with the same application or the same message sender, in the annunciator 105. The first flicking input and the second flicking input may be referred to as a list scroll input to scroll pieces of notification information (or notification data) in a specific notification list item.

The data processor 240 may process and digitally file a notification list as notification list data. For example, the data processor 240 may create notification list data by performing extensible markup language (XML) and object serialization of the notification list.

The storage 245 may store notification list data in a storage space. The storage space may include a logical memory and a physical memory such as a cache, a memory, and a database of the terminal, for example.

The storage 245 may store an un-filed notification list in a database of the system. The storage 245 may set a predetermined portion of RAM or other memories as a buffer and may directly store the un-filed notification list in the buffer.

The loader 250 may load notification list data from the storage space. In response to a touch input on the notification panel on which the notification list is displayed, the loader 250 may load notification list data including information about the corresponding notification list.

The restoration unit 255 may restore the notification list from the notification list data by objectifying the notification list data. The restoration unit 255 may restore the notification list by applying a scheme opposite to a filing scheme applied by the data processor 240.

The determiner 220 may determine whether a program having the same attribute as an attribute extracted by the extractor 215 from among attributes of programs stored in the terminal is extracted. The attribute may include whether it is a target to be updated, whether a data storage space is sufficient, and whether an error occurs.

The list creator 225 may create a notification list by applying the extracted attribute as a classification criterion with respect to programs having the same attribute as the extracted attribute. The list creator 225 may create the notification list so that programs having the same attribute may be included in a single notification list. In this case, notification data having a different identification value and/or title, but having the same attribute may be included in a single notification list, for example, an update notification of programs A, B, and C.

FIG. 3 illustrates an interface of processing and displaying a notification list according to an exemplary embodiment of the present invention.

Referring to FIG. 3, a notification list 310 including notification information associated with a game program, and notification lists 320 and 330 including notification information associated with a messenger program may be displayed on an annunciator 300. The notification lists 310, 320, and 330 may be referred to as notification list items, which are configured to include one or more pieces of notification data associated with the same application or associated with the same sender of a messenger application.

The notification list 310 includes, as notification information, content, a text, e.g., a message “Menu is well done,” with respect to AAA game. The notification list 310 may also include, as notification information, other contents in association with the AAA game. When new notification information associated with the AAA game is input to the terminal, a separate notification list may not be created and the new notification information may be added to the notification list 310. If the notification list 310 is associated with multiple unchecked notification messages of AAA game, the notification list 310 may indicate the number of unchecked notification messages and an interface to retrieve the unchecked notification messages. For example, left or right flicking gestures may retrieve unchecked notification messages one by one in which the notification messages are horizontally arranged as a sequential queue. Further, a list of unchecked notification messages may be retrieved in response to an unchecked notification message retrieval input, e.g., a pinch-to-zoom multi touch input on the notification list 310. In this scheme, a list of notification messages of the AAA game may be vertically displayed on an upper layer of the display screen. If the notification list 310 was deleted from the annunciator 300 by the user and new notification information is input to the terminal after the deletion, a new notification list for the AAA game may be created. The checked notification list, e.g., the notification list 310, or checked notification message in a notification list may be deleted automatically or manually. For example, if notification messages in a notification list 310 are displayed in response to a retrieval request, the displayed notification messages may be automatically deleted in response to an input to display other items on the screen. If the notification list 310 is associated with multiple (e.g., five) unchecked notification messages of AAA game, the five unchecked notification messages of AAA game may be displayed as horizontally scrolling items.

The notification lists 320 and 330 are associated with the same messenger program, but are distinguished based on a sender (1) 322 and a sender (2) 332 that are different from each other. The notification list 320 may include notification information associated with the sender (1) 322. For example, a message 323 received from the sender (1) 322, a count 324 indicating the number of messages unverified or unchecked by the user among messages received from the sender (1) 322, a time 325 at which a notification occurred, and the like may be included in the notification information. The notification list 330 may include notification information associated with the sender (2) 332.

When new notification information is input to the terminal later, the notification lists 320 and 330 may be updated to include additional information instead of creating a new notification list with respect to the sender (1) 322 and the sender (2) 332. When a new message is additionally received from the sender (1) 322 or the sender (2) 332 using the same program as the program of the notification list 320 or 330, a new notification list may not be created but the notification list 320 or 330 may be updated to include the new message. If the notification list 320 or 330 is deleted from the annunciator 300 by the user and new notification information is input to the terminal, the new notification list may be recreated with respect to the deleted notification list.

In response to a touch input on the notification panel on which the notification list 310 is displayed, previous notification information or subsequent notification information may be displayed.

Counts 324 and 334 may be displayed on a preset area, e.g., a right lower end portion of a notification list, of the notification lists 320 and 330, respectively. The counts 324 and 334 may indicate which item of notification information among items of unverified or unchecked notification information is displayed on the current display screen. When a flicking on the notification panel on which the notification list 320 or 330 is displayed is recognized, previous notification information or subsequent notification information may be displayed on the notification panel and the counts 324 or 334 may be updated. The counts 324 and 334 may include total number of unchecked notification messages and the index of the item currently displayed.

Although a basic notification scheme is used in FIG. 3, a big picture notification scheme, a big text notification scheme, an inbox style notification scheme, and the like may also be used. The basic notification scheme may provide simple and short notification information together with an icon of a program. The big picture notification scheme may provide notification information together with visual content, for example, a photo, such as a bitmap. The big text notification scheme may provide notification information including a text with relatively more lines of text compared to the basic notification scheme. The inbox style notification scheme may provide notification information including various types of lists, for example, messages and a headline of a program. Referring to FIG. 3, icons 321 and 331 of the program having created the respective notification may be positioned on the left side. If a program is provided in a messenger type, the sender (1) 322 and the sender (2) 332 are specified on a text positioned on a preset area, e.g., an upper center end, of each displayed list, and messages 323 and 333 are displayed. If the program is not a messenger type, a name of the program having created the notification is displayed. A detailed description about the notification is displayed on a lower center end, for example. If the program is not the messenger type program, contents and a detailed description of notification for each program may be displayed. Times 325 and 335 at which the notification occurred may be displayed on an upper right end. Counts 324 and 334 configured as an order or index of a current notification/a total number of unchecked notification messages for the notification list may be displayed on a lower right end.

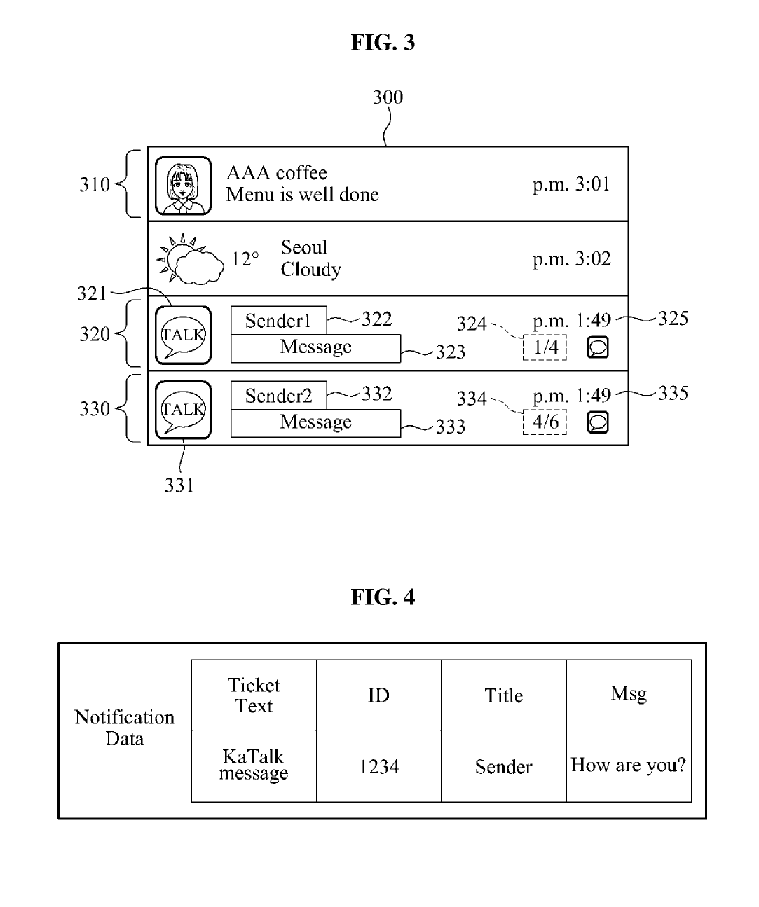

FIG. 4 illustrates a configuration of notification data input to a mobile terminal according to an exemplary embodiment of the present invention.

Referring to FIG. 4, primary data fields of notification data may include an identifier, a title, contents, and an attribute as information excluding user interface (UI) information. The user interface information and other data types may be categorized as secondary data fields. In an example of FIG. 4, “ID” may refer to the identifier, “Title” may refer to the title, and the contents may include “Ticket Text”, “Msg, and the like. “Ticket Text” is a message automatically displayed on a notification bar that is positioned on one side, for example, an upper end of a terminal screen in response to an occurrence of the notification. In a case in which KaKaoTalk (KaTalk) message is set as “Ticket Text” in the example of FIG. 4, in response to an occurrence of a notification, letters “KaTalk message” may be automatically displayed on the notification bar that is positioned on one side of a display screen of a mobile terminal, e.g., an upper end of the terminal screen.

“ID” is an identification field to classify a notification in the mobile terminal. Certain programs may use a variety of IDs and thus, “ID” may not function as an identification of a specific program. In this case, “Title” may be used as an identification of the program. In the example of FIG. 4, “1234” is used as “ID” indicating the KaTalk program. The mobile terminal stores ID information of various programs. Therefore, when “1234” is included as “ID” in the notification data, the mobile terminal may verify the ID “1234” and interpret that the notification data is associated with the KaTalk program.

“Title” is information about the title of the notification. If the program is not a messenger type, a name of the program may generally correspond to “Title”. Otherwise, information about a sender of a message may be included. In the example of FIG. 4, the KaTalk program corresponds to a messenger program and thus, information associated with a sender is included in the “Title” field.

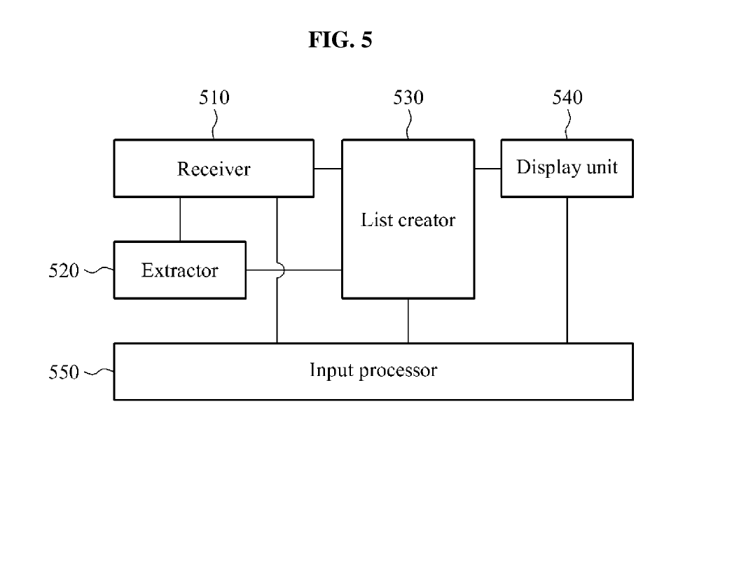

“Msg” corresponds to detailed information associated with the notification and may include a detailed description of the notification or a message description. In the example of FIG. 5, the KaTalk program corresponds to the message program and a message such as “How are you?” may be parsed and categorized as “Msg” field.

FIG. 5 illustrates a mobile terminal to provide a notification processing interface according to another exemplary embodiment of the present invention.

Referring to FIG. 5, the mobile terminal to provide a notification processing interface may include a receiver 510, an extractor 520, a list creator 530, a display unit 540, and an input processor 550. Compared to the configuration of the mobile terminal of FIG. 2, FIG. 5 shows a different configuration in which notification list data, e.g., filing of a notification list, is not created. Also, each of the constituent elements of FIG. 5 may be physically configured in a single hardware component or separate hardware components. Thus, at least two of the constituents elements illustrated in FIG. 5 may be configured in a single hardware component, but may be logically and functionally separate.

The receiver 510 may receive notification data about a program. For example, the receiver 510 may receive program related information from a web server. Program related information may include various types of information such as a message, update information, request a friend, and new feed information, for example.

Program related information may be input as notification data for providing information associated with a program to a terminal. Notification data may have a predetermined format, and notification data created in a predetermined format on a web server may be sent. Program related information received from a notification service block of the terminal may be reconfigured as a predetermined format.

The extractor 520 may extract, from the notification data received by the receiver 510, identification information for identifying a target of a notification and content including a description of the notification. Here, the identification information may include at least one of an identifier for the program, a title, and an attribute. The title may include at least one of a name of the program and a sender sending a message using the program.

For example, the identifier of the program may be an identification (ID) indicating the program. Meanings of the identifier, the title, and the content may differ based on a type of the program.

For example, the type of the program may be generally classified into a messenger type and a non-messenger type.

If the program is a messenger type program in which multiple users can send messages using the program, the identifier may match a name of the program, the title may include a sender sending a message using the program, and the content may include a detailed description of the message. For example, an ID of the program stored in the terminal is identical to an identifier included in notification data and a matching name of the program may be retrieved from the identifier of notification data.

If the program is not a messenger type program, the title may include a name of the program and the content may include a detailed description of a notification. For example, if the program is of a mobile web game genre, the content may include information about a schedule that needs to be periodically performed on a game. If the program is not of a messenger type, an identifier indicating the same program may be frequently changed. Accordingly, the program may not be accurately identified using the identifier of the program alone. The same program may be identified using the title field. Also, the program may be identified using a combination of the identifier and the title fields.

Whether the program is provided in the messenger type or not may be determined based on the identifier of the notification data.

The input processor 550 may determine whether the program is provided in the messenger type using an attribute of notification data and may identify the same program using the identifier and/or the title based on the determination result. In the example of FIG. 5, the input processor 550 may also perform one or more operations of the determiner 220 of FIG. 2.

The list creator 530 may create a notification list based on various classification conditions/criteria according to settings of a user or a system.

For example, the list creator 530 may create at least one notification list by grouping contents of notification data based on identification information. The list creator 530 may create a notification list based on at least one of the identifier and the title. The list creator 530 may create a notification list based on at least one of the extracted identifier and title.

For example, the list creator 530 may create a notification list by applying, as a classification condition, at least one of the identifier and the title extracted by the extractor 520.

The list creator 530 may create a separate notification list for each title using the same program. For example, when the program is of a messenger type, the list creator 530 may create a notification list for each message sender. If different senders sent message to the user of the mobile terminal using the same messenger program, different notification lists may be created for each message sender. Since a notification list is created for each sender, a user may verify a received message for each sender without executing a program.

In generating a notification list for a messenger program, different message senders may be distinguished by the title field and categorized into different notification lists for the same messenger program. Further, messages from the same message sender using different messenger programs may be categorized into the same notification list. For example, a first message from a sender A using KaKaoTalk messenger, a second message from the sender A using Facebook messenger may be categorized into the same notification list. In this case, the icons of the KaKaoTalk and Facebook programs may be displayed in the notification list to indicate messages from the same sender have been received using different messenger programs. Alternatively, a notification list indicating a Facebook message from sender A and a notification list indicating a KaKaoTalk message from sender A may be sorted such that the two associated notification lists may be displayed adjacent to each other, displayed consecutively, or the like.

As another example, with respect to a program having the same title as the title extracted by the extractor 520, the list creator 530 may create a notification list including contents based on the extracted title. If the same program is identified using the title, the list creator 530 may create a notification list including contents using the same program. For example, if the program is provided in a game type, the list creator 530 may create a single notification list with respect to the same game program. Since a single notification list is created, relevant information may be briefly displayed for each program on the annunciator.

If the program is provided in a messenger type, the notification list may include at least one of an icon of the program, a sender sending a message using the program, a detailed description of the message, a creation time or update time of the notification list, a total number of messages received from the sender, and a number of messages unverified or unchecked from among the entire messages.

Also, the notification list may include an order or index of notification information currently displayed on the notification panel.

If the program is not provided in the messenger type, the notification list may include an icon of the program, a name of the program, a detailed description of a notification that occurs in the program, a creation time or update time of the notification list, the number of unchecked notification information with respect to the program, and an order or index of notification information currently displayed on the notification panel among the entire sets of unchecked notification information.

The display unit 540 may display each notification list on the notification panel. Each notification list may be classified based on a classification criterion and be displayed on the notification panel. The classification criterion may be variously set based on settings of a user or a system.

In response to a touch input on the notification panel, the display unit 540 may display notification information that is temporally previously reflected in the notification list.

In response to a gesture event, the display unit 540 may display each of contents included in the notification list in an order of time or other sorting criteria.

The input processor 550 may recognize a user input. The user input may include a touch input and/or a non-touch input. The non-touch input may include a variety of non-touch inputs such as a motion input recognized by a motion recognition sensor, e.g., an image sensor, and a voice input recognized by a voice recognition module. For example, the motion recognition may be a scheme of recognizing a motion of a user horizontally moving a hand in front of a camera of a mobile terminal. The motion recognition may be a scheme of horizontally moving an outer object or shaking the mobile terminal.

For example, in response to a touch input on the notification panel, the input processor 550 may recognize a gesture event matching the touch input. The input processor 550 may recognize a drag, a flicking, and the like, based on a direction of the touch input. The input processor 550 may recognize a multi-touch input based on the number of multiple touches. The input processor 550 may apply, to the notification list, a process set with respect to the recognized gesture event.

A processing scheme may be set for each gesture event. For example, a processing scheme of displaying previous notification information may be set with respect to a first flicking, e.g., a flicking in a direction from the left to the right, and a processing scheme of displaying subsequent notification information may be set with respect to a second flicking, e.g., a flicking in a direction from the right to the left. Also, a process of deleting a notification list corresponding to a touch input may be set with respect to a long press touch. A variety of processing schemes may be set with respect to various gestures using a touch input.

For example, in response to a gesture event, the input processor 550 may sequentially display or delete contents included in a corresponding notification list.

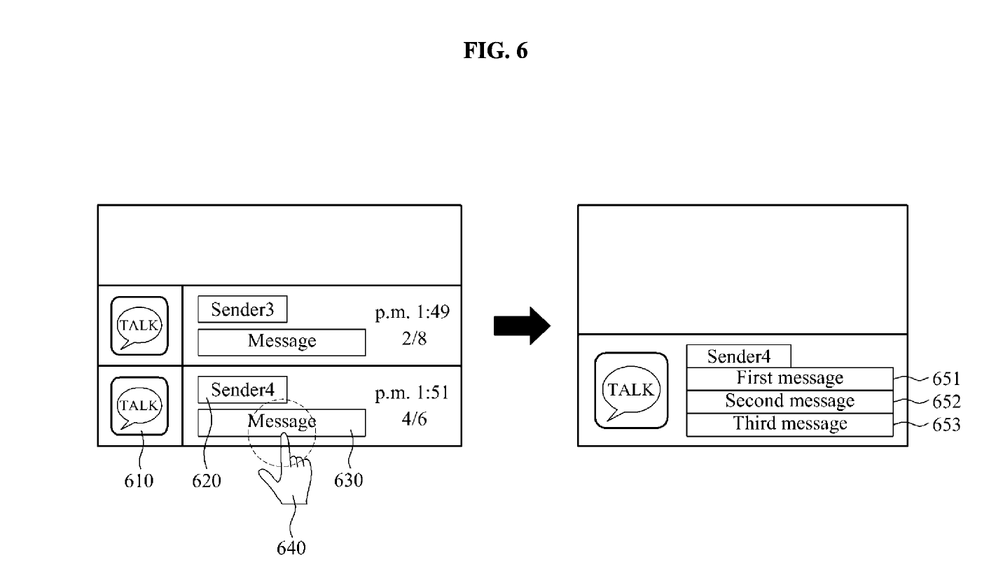

FIG. 6 illustrates an interface of displaying a process of verifying a previous notification item and/or list using a mobile terminal according to an exemplary embodiment of the present invention.

Referring to FIG. 6, if a program creating a notification is provided in a messenger type, a notification list displayed on a notification panel may include an icon 610 of the program, sender information 620, a message 630, a notification creation time or update time, a count indicating an order of notification information currently displayed on the notification panel, and the like.

In response to a touch input 640 on a portion corresponding to the message 630 on the notification panel, detailed notification information may be displayed on the notification panel. For example, a first message 651, a second message 652, and a third message 653 received from the sender (4) may be displayed. The first message 651 may be notification information received before receiving the second message 652, and the third message 653 may be notification information received after receiving the second message 652 or vice versa.

A user input may be a drag or a flicking in one direction if the user input is a touch input. If a motion input is used as the user input, for example, a gesture or motion input in one direction or a motion of moving or shaking the mobile terminal in one direction may be recognized. If a voice input is used as a user input, the voice input, such as “previous message” and “next message”, may be used to process the message scrolling.

In response to the user input, each of the messages 651, 652, and 653 may be displayed one by one. Also, in response to the user input, the messages 651, 652, and 653 may be displayed and the size of the notification panel is extended.

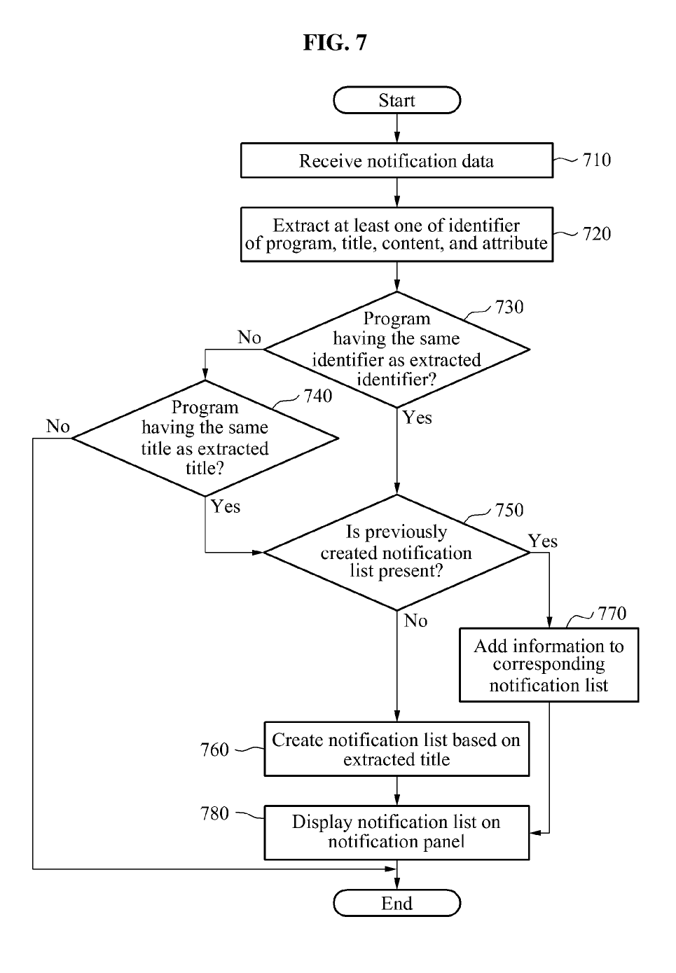

FIG. 7 illustrates a method for processing notification information according to an exemplary embodiment of the present invention.

In operation 710, a mobile terminal may receive notification data about a program.

In operation 720, the mobile terminal may extract, from the notification data, identification information for identifying a target of a notification and content including a description of the notification. Here, the identification information may include at least one of an identifier for identifying a program, a title, and an attribute. The title may include at least one of a name of the program and/or a sender sending a message using the program.

In operation 730, the mobile terminal may determine whether a program having the same identifier as the extracted identifier exists among programs stored in the terminal.

If the program having the same identifier as the extracted identifier does not exist, the mobile terminal may determine whether a program having the same title as the extracted title exists among the programs stored in the terminal in operation 740.

If the program having the same identifier as the extracted identifier exists, the mobile terminal may verify whether a notification list previously created with respect to the program having the same identifier exists in operation 750. If it is determined that the program having the same title as the extracted title exists, the mobile terminal may verify whether a notification list previously created with respect to the program having the same title exists.

If the previously created notification list having the identifier is determined to be absent, the mobile terminal may create a notification list including the contents by applying the extracted identifier as a classification criterion with respect to the program having the same identifier in operation 760. Further, if the previously created notification list having the title is verified to be absent, the mobile terminal may create a notification list including the contents by applying the extracted title as a classification criterion with respect to the program having the same title.

If the previously created notification list exists, the mobile terminal may add or update new notification information to the created notification list in operation 770.

In operation 780, the mobile terminal may display, on the notification panel, the notification list classified based on a classification criterion. For example, the notification list may be a newly created notification list and may also be a notification list in which new notification information is added to a previously created notification list.

The mobile terminal may file the created notification list as notification list data and may store the notification list data in a storage space. Also, the mobile terminal may store an unfiled notification list in a system database. Also, the mobile terminal may set a predetermined portion of a memory, e.g., a RAM, as a buffer and may directly store the un-filed notification list in the buffer.

In response to a touch input on the notification panel, the mobile terminal may recognize a gesture event matching the touch input, and may apply, to the notification list, a process set for the recognized gesture event. The mobile terminal may recognize a user input. The user input may include a touch input and/or a non-touch input. The non-touch input may include a variety of non-touch inputs, such as a motion recognition and a voice recognition. For example, the motion recognition may be a scheme of recognizing a motion of a user moving a finger on a camera or an image sensor of a mobile terminal. The motion recognition may be a scheme of horizontally moving or shaking the mobile terminal.

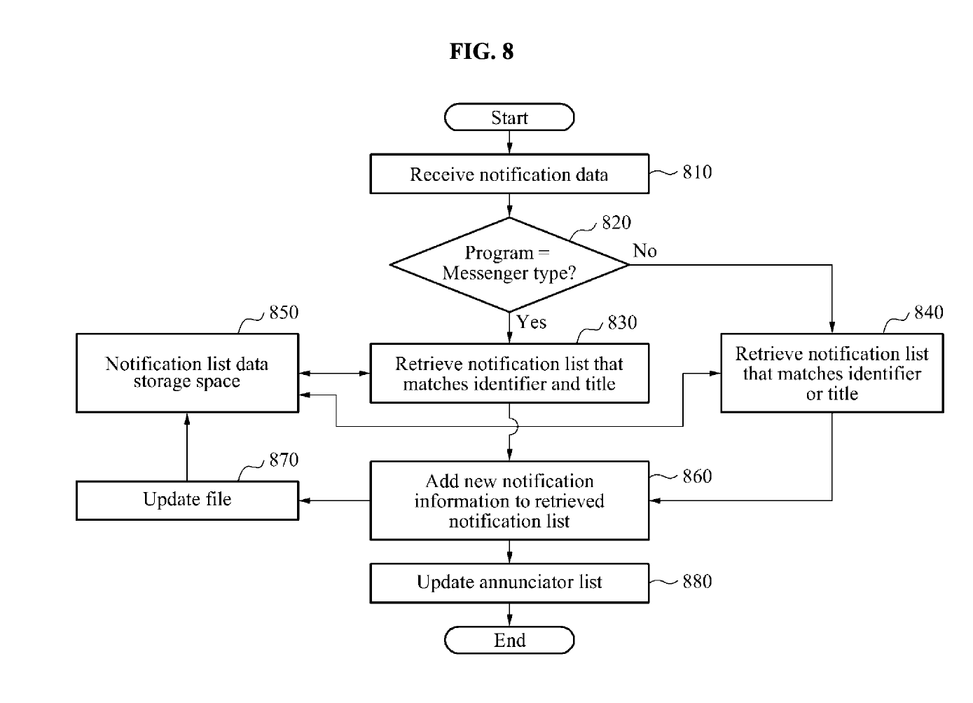

FIG. 8 illustrates a method for processing notification information according to an exemplary embodiment of the present invention.

In operation 810, a mobile terminal may receive notification data about a program.

In operation 820, the mobile terminal may determine whether a program having created a notification is provided in a messenger type. The mobile terminal may extract an identifier of the program from the notification data. For example, if the extracted identifier is determined to be identical to a pre-stored identifier, the program may be determined to be a messenger type program. Further, a type of a program may be determined based on whether the type of the program corresponding to the pre-stored identifier matching the extracted identifier is provided in the messenger type.

If the program having created the notification is provided in the messenger type, the mobile terminal may retrieve, from a notification list data storage space (operation 850), a notification list that matches an identifier and a title in operation 830. Notification list data may be created by processing the notification list in a file format. An example of creating a file may include an XML, serial-objectification, and the like. When inverse filing of notification list data is performed, the notification list may be restored.

If the program having created the notification is not provided in the messenger type, the mobile terminal may retrieve, from the notification list data storage space, a notification list that matches an identifier or a title in operation 840.

In operation 860, the mobile terminal may update the retrieved notification list by adding new notification information to the retrieved notification list.

In operation 870, the mobile terminal may update an existing file by filing the updated notification list.

In operation 880, the mobile terminal may update an annunciator list by applying the updated notification list. As another example, if the program having created the notification is not provided in the messenger type, the mobile terminal may retrieve, from the notification list data storage space, a notification list that matches an attribute. The mobile terminal may update the retrieved notification list and the annunciator list by adding new notification information, e.g., a program to be updated, to the retrieved notification list.

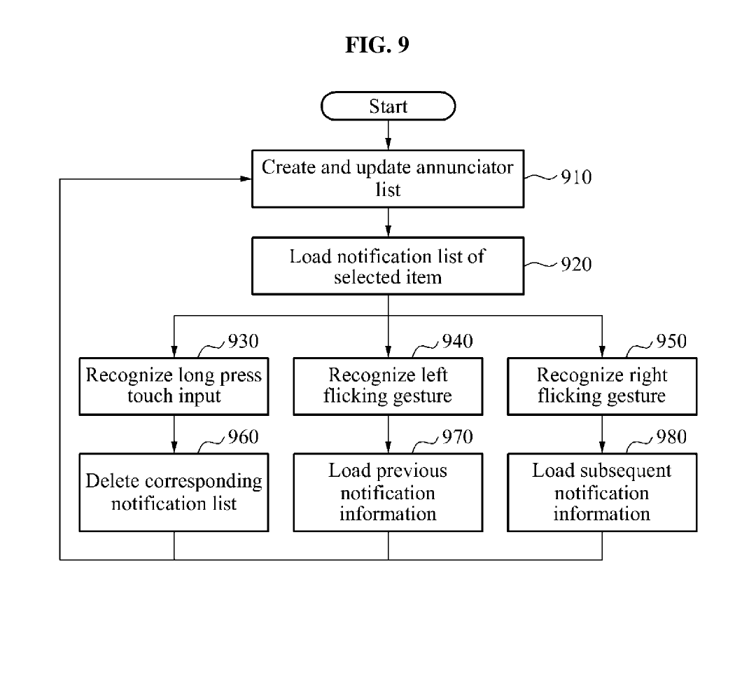

FIG. 9 illustrates a method for processing notification information according to still another exemplary embodiment of the present invention.

In operation 910, a mobile terminal may create and/or update an annunciator list by loading, from a storage space, a notification list stored as a file.

In operation 920, the mobile terminal may load, from the storage space, a notification list of an item selected by a user from among annunciator lists.

Here, the notification list may include notification information that is accumulated with respect to a predetermined program. If a program having created a notification is provided in a messenger type, the notification list may include messages that are received from a specific message sender, but has not yet been verified or checked.

In operation 930, the mobile terminal may recognize a long press touch input on a notification panel.

In operation 960, the mobile terminal may perform a processing operation corresponding to the long press touch input. A notification list corresponding to the long press touch input may be deleted from the notification panel. For example, the notification list may be deleted only from the annunciator list. Notification list data may be stored in the storage space.

In operation 940, the mobile terminal may recognize a first flicking gesture in response to a touch input recognized on the notification panel. The first flicking gesture may be a flicking gesture from the left to the right.

In operation 970, the mobile terminal may load, from the storage space, previous notification information of notification information that is currently displayed on the notification panel. The mobile terminal may apply the loaded notification information to the annunciator list.

In operation 950, the mobile terminal may recognize a second flicking gesture in response to a touch input recognized on the notification panel. The second flicking gesture may be a flicking gesture from the right to the left.

In operation 980, the mobile terminal may load, from the storage space, subsequent notification information of notification information that is currently displayed on the notification panel. The mobile terminal may apply the loaded notification information to the annunciator list.

For example, in response to a user input, e.g., a short touch on a notification list including the loaded notification information, the mobile terminal may execute a program associated with the notification list and may display a screen of the corresponding event. For example, in a case in which the notification list includes messages communicated with a sender A, if the user of the mobile terminal inputs a short touch while viewing details of messages, the mobile terminal may execute a relevant messenger program using a conversation page between the user of the mobile terminal and the sender A, and may change the screen by displaying the linked location of the messenger program in which the communicated messages between the user and the sender A are displayed.

The number of sets of notification information stored in a notification list may be determined based on settings. Unless a memory capacity of the mobile terminal is limited, notification information may be accumulated and thereby be stored until the user deletes the notification information from an annunciator.

According to aspects of the present invention, notification processing may be operated to manage and classify updated information such that a user may check and manage updated notification lists while reducing the need to retrieve each application that has updated information. As described above, the mobile terminal creates and maintains a notification list in a display screen. The notification list may be displayed in an annunciator and may include multiple notification items. Among notification items, some notification information may be relatively less informative or less important. As the number of different types of notification items increases, it may be inconvenient for the user to check and delete each of the notification items to maintain clean notification list. If the user does not delete notification items in a timely manner, more important notification information may not be easily recognized by the user because of many unchecked notification items. As described above, such problems may be partly addressed by grouping notification items based on e.g., the identifier, title, attribute, and the like.

A specific piece of notification information included in a notification list item may be protected from deletion if the user of the mobile terminal sets a deletion lock for the specific piece of notification information. For example, a user may want to maintain a piece of notification information to be maintained in the notification list without deletion and the user may set the deletion lock for the piece of notification information. The deletion lock may be unlocked by a user input and the unlocked item may be deleted according to a configured deletion policy for the notification information. The protected notification item may be determined as a relatively important notification item and the mobile terminal may generate a periodical notification sound or visual message for the protected item multiple times according to a setting.

According to exemplary embodiments of the present invention, if a relevant program is provided in a messenger type, a notification list may accumulate and thereby store a message sent from a sender, but may also store a message sent from a mobile terminal to the sender and may also display the message sent from the mobile terminal to the sender on the annunciator.

Further, a notification list may be created by classifying a sender of a message and thus, may display a message to be distinguished from an existing message. Accordingly, a user may verify a message received for each sender.

A sender may also be distinguished on a notification list. Accordingly, a user may check notification information for each sender and may also check a message sent from the user to the sender on the notification list by storing a message for each sender.

By filing and storing notification information, a previous message may be verified on the annunciator list without executing a program.

In a case in which an identifier is different but an attribute of a notification is related to a status change of a certain application, such as “program update complete”, version status change of a certain application, a download status of a certain application, and the like, the notification may be recognized as the same attribute of the attribute of the application and the notification may be included in a single notification list with respect to the application having the same attribute.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method that uses a processor to process notification information, the method comprising:
receiving first notification data associated with a first application installed in a mobile terminal;
extracting identification information for identifying a target of the first notification data;
generating a first notification list item by grouping the first notification data with second notification data based on the identification information; and
displaying notification list items comprising the first notification list item on a notification panel.

2. The method of claim 1, wherein the first notification list item is updated to display the first notification data in the first notification list item if the first notification list item is updated by grouping the first notification data with at least one notification data associated with the first application, the at least one notification data associated with the first application comprising the second notification data.

3. The method of claim 1, further comprising:
when the first notification data is displayed in the first notification list item, receiving a list scroll input to display the second notification data in the first notification list item.

4. The method of claim 1, further comprising:
when the first notification data is displayed in the first notification list item, receiving a linked portion retrieval input to execute the first application and to display a linked portion of the first application on a display screen, the linked portion being associated with the first notification data.

5. The method of claim 1, further comprising:
when the first notification data is displayed in the first notification list item, receiving a notification deletion input to delete the first notification data from the first notification list item.

6. The method of claim 1, further comprising:
determining whether the first notification data is associated with a first type application;
extracting a subcategory from the first notification data if the first application is the first type application;
grouping the first notification data according to the subcategory.

7. The method of claim 6, wherein the first type application comprises a messenger type application, and the subcategory comprises a sender of a message using the first application.

8. The method of claim 6, further comprising:
determining whether the first notification data is associated with a second type application;
grouping the first notification data without considering a subcategory if the first application is the second type application.

9. The method of claim 8, wherein the second type application corresponds to a non-messenger type application.

10. The method of claim 1, wherein the first notification list item comprises an identifier of the first application, a sender, a message, and an index of unchecked notification messages for the first application.

11. The method of claim 10, further comprising displaying multiple messages if the message comprised in the first notification list item is selected, wherein the message is configured to be selected by a user.

12. The method of claim 1, wherein the first notification data comprises at least one of a ticket text field, an identification field, a title field, and a message field.

13. A mobile terminal to process notification information, comprising:
a receiver to receive first notification data associated with a first application installed in a mobile terminal;
a processor to extract identification information for identifying a target of the first notification data, and to generate a first notification list item by grouping the first notification data with second notification data based on the identification information; and
a display screen to display notification list items comprising the first notification list item on a notification panel.

14. The mobile terminal of claim 13, wherein the first notification list item is updated to display the first notification data in the first notification list item if the first notification list item is updated by grouping the first notification data with at least one notification data associated with the first application, the at least one notification data associated with the first application comprising the second notification data.

15. The mobile terminal of claim 13, further comprising:
a user interface to receive a list scroll input to display the second notification data in the first notification list item when the first notification data is displayed in the first notification list item.

16. The mobile terminal of claim 13, further comprising:
a user interface to receive a linked portion retrieval input to execute the first application and to display a linked portion of the first application on a display screen when the first notification data is displayed in the first notification list item, the linked portion being associated with the first notification data.

17. The mobile terminal of claim 13, further comprising:
a user interface to receive a notification deletion input to delete the first notification data from the first notification list item when the first notification data is displayed in the first notification list item.

18. A method that uses a processor to process notification information, the method comprising:
receiving first notification data associated with an application installed in a mobile terminal;
extracting identification information for identifying a target of the first notification data;
determining if the application is of a first type or of a second type, based on the extracted identification information;
generating a first notification list item by grouping the first notification data with second notification data based on the identification information and the determined type of the application; and
displaying notification list items comprising the first notification list item on a notification panel.

19. The method of claim 18, wherein the first type corresponds to a messenger type application, and the second type corresponds to a non-messenger type application.

20. The method of claim 18, further comprising:
extracting sender information from the first notification data if the application is determined to be an application of the first type; and
grouping the first notification data based on the sender information.
